(19) United States
(12) Patent Application Publication
(10) Pub. No.: US 2018/0264585 A1
(43) Pub. Date: Sep. 20, 2018

(54) HIGH TENSILE STRENGTH SHANK ASSEMBLY

(71) Applicants: JUSTIN ANDERSON LITTELL, Huntsville, AL (US); Damon Cleghorn, Addison, AL (US)

(72) Inventors: JUSTIN ANDERSON LITTELL, Huntsville, AL (US); Damon Cleghorn, Addison, AL (US)

(21) Appl. No.: 15/462,145

(22) Filed: Mar. 17, 2017

(51) Int. Cl. B23K 20/12

(52) U.S. Cl. CPC B23K 20/1255

(57) ABSTRACT

A high-tensile-strength shank assembly includes a shaft assembly. A first distal end is configured to releasably engage a friction plug assembly. A second distal end is configured to releasably engage a friction pull welder assembly.

### GOVERNMENT LICENSE RIGHTS

This invention was made with government support under Contract NNM12AA41C awarded by NASA. The government has certain rights in the invention.

### TECHNICAL FIELD

This disclosure relates to shank assemblies and, more particularly, to high tensile strength shank assemblies.

### BACKGROUND

Stir welding systems are often utilized to join various pieces of material, wherein such stir welding systems provide exceptional high quality welds that avoid many of the shortcomings of traditional welding techniques. Unfortunately, at the end of a Self-Reacting Frisction Stir Weld (SR-FSW) joint produced using a stir welding procedure, a hole often perforates the pieces of material that were being joined. These holes are typically filled using a pull welding system that pulls a rotating plug of similar material through the hole using a rotating shank assembly. Unfortunately, these shank assemblies are often made of materials that lack the strength required to avoid failure during the rotating/pulling procedure.

### SUMMARY OF DISCLOSURE

In one implementation, a high-tensile-strength shank assembly includes a shaft assembly. A first distal end is configured to releasably engage a friction plug assembly. A second distal end is configured to releasably engage a friction pull welder assembly.

One or more of the following features may be included. The first distal end may include a thread assembly configured to releasably engage the friction plug assembly. The second distal end may include a thread assembly configured to releasably engage the friction pull welder assembly. The friction plug assembly may be a flared friction plug assembly. The first distal end may include a flared portion having a flare profile similar to the flared friction plug assembly. The high-tensile-strength shank assembly may be constructed of a material having a tensile strength of at least 20,000 pounds per square inch. The high-tensile-strength shank assembly may be constructed of a ferrous material. The high-tensile-strength shank assembly may be constructed of inconel. The friction plug assembly may be constructed of a nonferrous material. The friction plug assembly may be constructed of aluminum.

In another implementation, a high-tensile-strength shank assembly includes a shaft assembly. A first distal end is configured to releasably engage a friction plug assembly. The first distal end includes a thread assembly configured to releasably engage the friction plug assembly. The friction plug assembly is constructed of aluminum. A second distal end is configured to releasably engage a friction pull welder assembly.

One or more of the following features may be included. The second distal end may include a thread assembly configured to releasably engage the friction pull welder assembly. The friction plug assembly may be a flared friction plug assembly. The first distal end may include a flared portion having a flare profile similar to the flared friction plug assembly. The high-tensile-strength shank assembly may be constructed of a material having a tensile strength of at least 20,000 pounds per square inch. The high-tensile-strength shank assembly may be constructed of a ferrous material. The high-tensile-strength shank assembly of claim 11 wherein the high-tensile-strength shank assembly is constructed of inconel. The friction plug assembly may be constructed of a nonferrous material.

In another implementation, a high-tensile-strength shank assembly includes a shaft assembly. A first distal end is configured to releasably engage a friction plug assembly. The first distal end includes a thread assembly configured to releasably engage the friction plug assembly. The friction plug assembly is constructed of aluminum. A second distal end is configured to releasably engage a friction pull welder assembly. The second distal end includes a thread assembly configured to releasably engage the friction pull welder assembly. The high-tensile-strength shank assembly is constructed of a ferrous material.

One or more of the following features may be included. The high-tensile-strength shank assembly may be constructed of a material having a tensile strength of at least 20,000 pounds per square inch.

The details of one or more implementations are set forth in the accompanying drawings and the description below. Other features and advantages will become apparent from the description, the drawings, and the claims.

### BRIEF DESCRIPTION OF THE DRAWINGS

FIGS. 1A-1C are diagrammatic views of a stir welding system according to an implementation of the present disclosure;

FIG. 2A is a perspective view of a high-tensile-strength shank assembly and a flare plug assembly according to an implementation of the present disclosure;

FIGS. 2B-2D are diagrammatic views of the high-tensile-strength shank assembly and flare plug assembly of FIG. 2A according to an implementation of the present disclosure;

FIGS. 3A-3C are additional diagrammatic views of the high-tensile-strength shank assembly and flare plug assembly of FIG. 2A according to an implementation of the present disclosure;

FIGS. 3D-3F are diagrammatic views of alternative embodiments of the flare plug assembly of FIG. 2A according to an implementation of the present disclosure; and

FIG. 4A-4C are diagrammatic views of a pull welding system that utilizes the high-tensile-strength shank assembly and flare plug assembly of FIG. 2A according to an implementation of the present disclosure.

Like reference symbols in the various drawings indicate like elements.

### DETAILED DESCRIPTION OF THE PREFERRED EMBODIMENTS

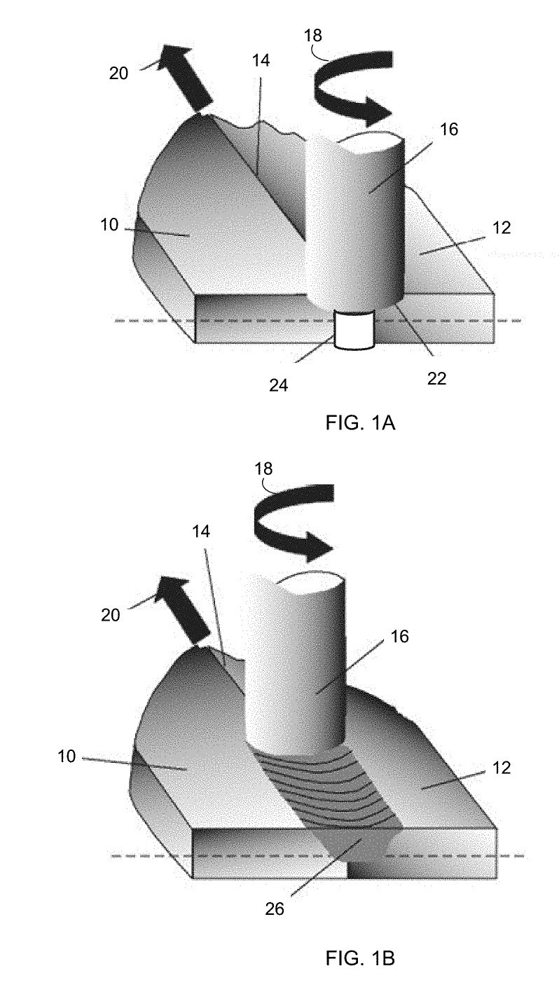

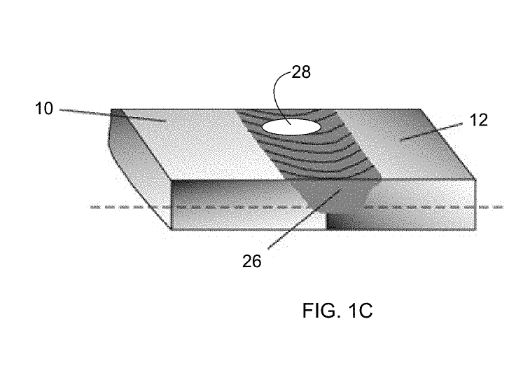

Referring to FIGS. 1A-1C, there is shown an illustration of a Self-Reacting Frisction Stir Weld (SR-FSW) process. Friction stir welding may be used to join two pieces of similar material (e.g., pieces 10, 12) that are aligned side-by-side to form butt joint 14. During the stir welding procedure, stir welding tool 16 is rotated (in the direction of arrow 18) and moved along butt joint 14 (in the direction of arrow 20), while downward pressure is applied. Stir welding tool 16 (which includes shoulder portion 22 and probe portion 24) generates considerable frictional heat that softens pieces 10, 12, thus allowing the material of pieces 10, 12 to be “stirred” together to create weld joint 26. During the friction stir welding procedure, probe portion 24 deeply penetrates butt joint 14 while shoulder portion 22 smoothes weld joint 26. During this stir welding procedure (and depending upon the length of probe portion 24, the thickness of pieces 10, 12, and the desired penetration of weld joint 26, a hole (e.g., hole 28, FIG. 1C) may be left that penetrates pieces 10, 12 at the end of weld joint 26.

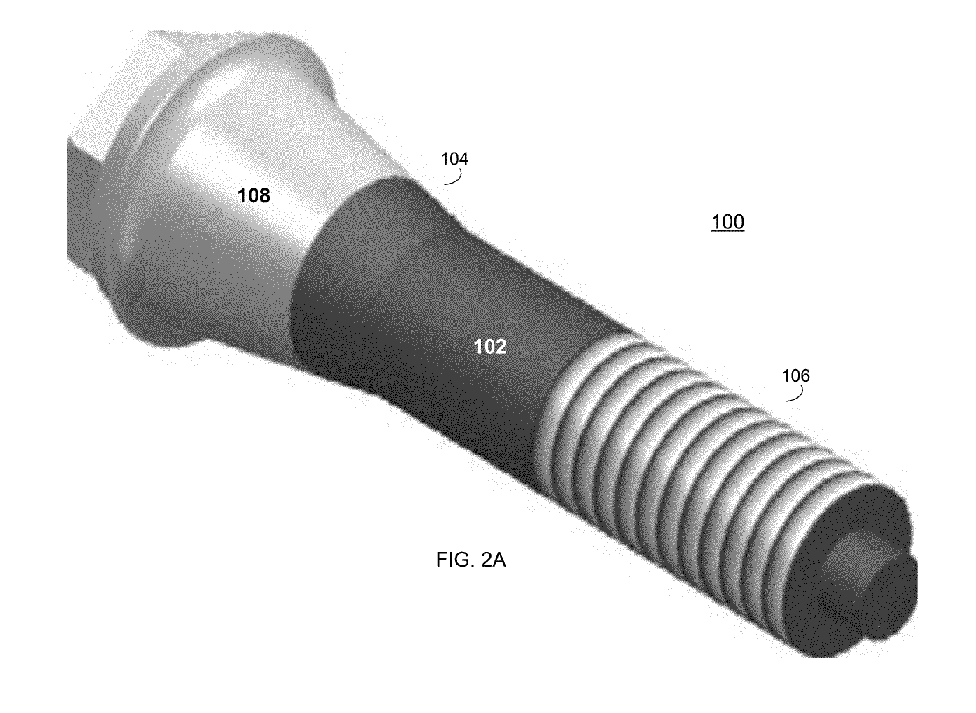

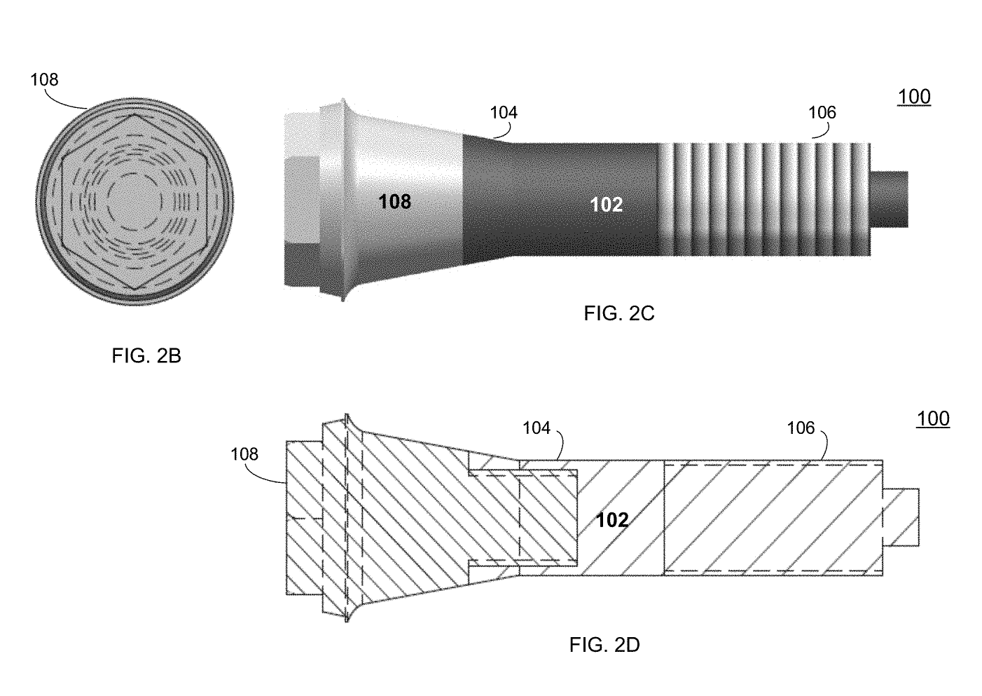

Referring also to FIGS. 2A-2D, there is shown high-tensile-strength shank assembly 100, which may be utilized as a portion of a tool that is designed to fill hole 28. In this particular embodiment, high-tensile-strength shank assembly 100 is shown to include shaft assembly 102, first distal end 104 and second distal end 106. First distal end 104 may be configured to releasably engage friction plug assembly 108. In this particular example and as is explained below, friction plug assembly 108 is the filler material that may be used to hole 28. High-tensile-strength shank assembly 100 may be constructed of a material having a tensile strength of at least 20,000 pounds per square inch, such as a ferrous material (e.g., tool steel) or a high-strength alloy (e.g., Inconel), wherein friction plug assembly 108 may be constructed of a nonferrous material (e.g., aluminum).

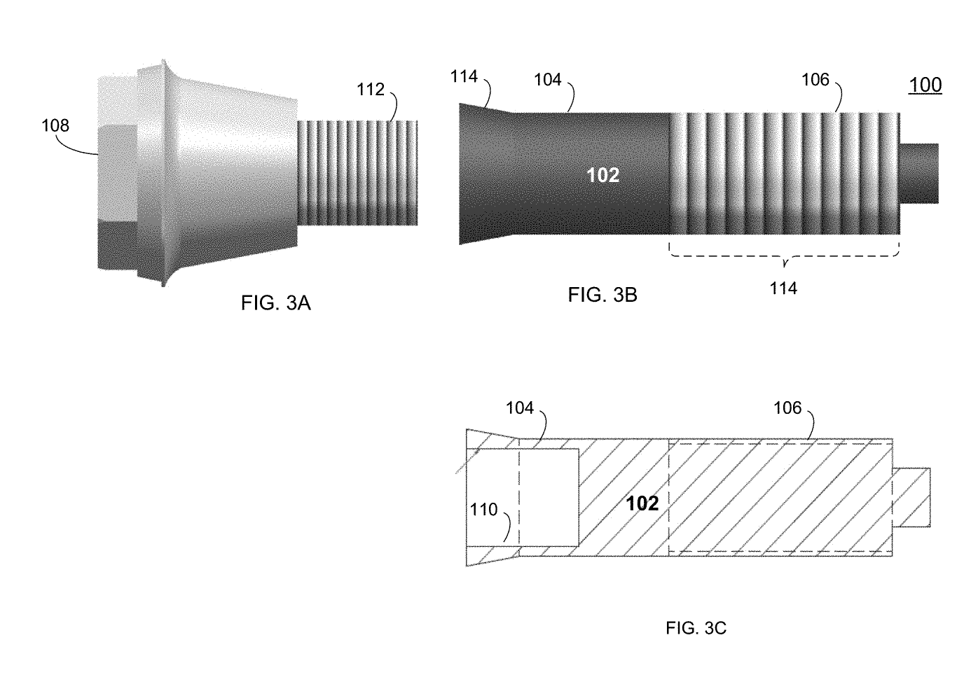

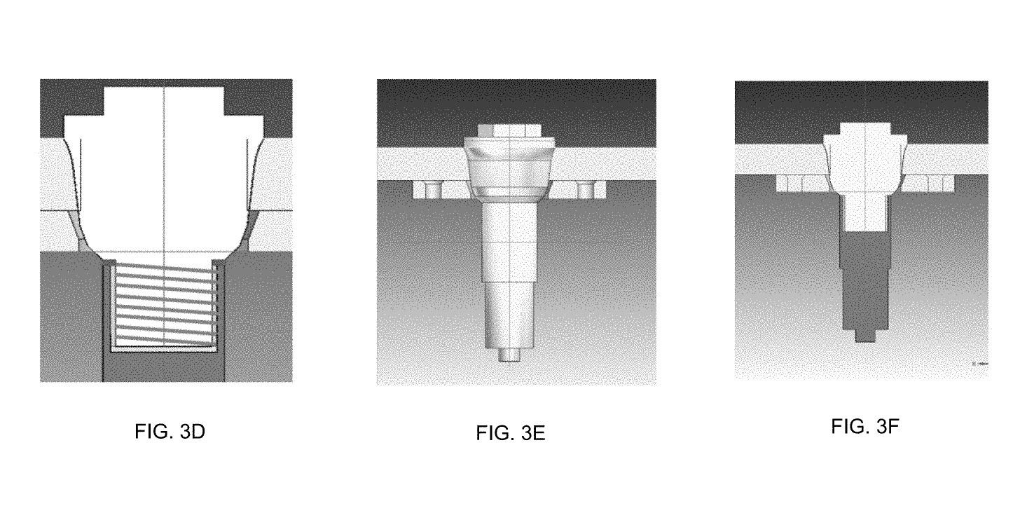

Referring also to FIGS. 3A-3C, first distal end 104 of high-tensile-strength shank assembly 100 may include thread assembly (e.g., female thread assembly 110) configured to releasably engage friction plug assembly 108. For example, friction plug assembly 108 may include external male thread assembly 112 that is configured to releasable engage female thread assembly 110 of first distal end 104 of high-tensile-strength shank assembly 100. Note that friction plug assembly 108 “bottoms out” on first distal end 104 of high-tensile-strength shank assembly 100, thus allowing for the absorption of the torsional stress induced by the Self-Reacting Frisction Stir Weld (SR-FSW) process so that external male thread assembly 112 of friction plug assembly 108 does not break due to e.g., the combined torsional and normal stresses (as shown in FIG. 3D).

Second distal end 106 may be configured to releasably engage a friction pull welder assembly (to be discussed below in great detail). For example, second distal end 106 may include thread assembly 114 that may be configured to releasably engage the friction pull welder assembly. Friction plug assembly 108 may be a flared friction plug assembly and first distal end 104 of high-tensile-strength shank assembly 100 may include flared portion 114 having a flare profile similar to that of the flare of friction plug assembly 108. Alternatively, friction plug assembly 108 may not be flared and may be configured in various shapes/profiles (as shown in FIGS. 3E-3F).

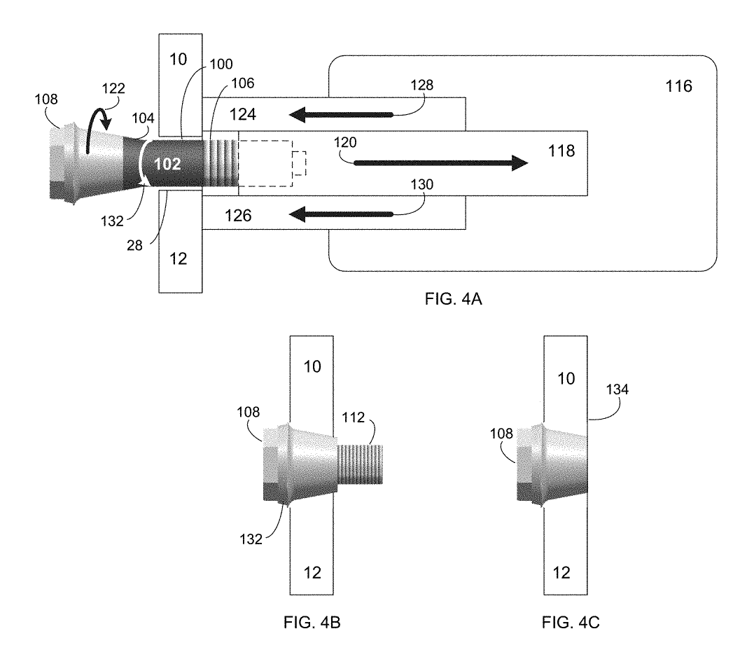

As discussed above and referring also to FIG. 4A, second distal end 106 of high-tensile-strength shank assembly 100 may be configured to releasably engage friction pull welder assembly 116. For example, friction pull welder assembly 116 may include movable ram assembly 118 that (during operation) may be configured to move in the direction of arrow 120 while rotating high-tensile-strength shank assembly 100 (and, therefore, friction plug assembly 108) in the direction of arrow 122. Additionally, stand assemblies 124, 126 may be configured to move in the direction of arrows 128, 130 (respectively). Specifically, the net result is that ram assembly 118 is displaced in a direction opposite to that of stand assemblies 124, 126 while rotating high-tensile-strength shank assembly 100 (and, therefore, friction plug assembly 108) in the direction of arrow 122 at a rate sufficient enough (e.g., 6,500 rpm) to generate enough friction to soften pieces 10, 12 and friction plug assembly 108 resulting in a welding procedure similar to the above-described stir welding procedure.

For example, if hole 28 needs to be filled, hole 28 may first be sized using a drill (not shown) to ensure proper size and shape. High-tensile-strength shank assembly 100 (without friction plug assembly 108 installed) may be inserted through hole 28 and then friction plug assembly 108 may be threaded onto high-tensile-strength shank assembly 100 in the direction of arrow 132. High-tensile-strength shank assembly 100 (and, therefore, friction plug assembly 108) may then be rotated in the in the direction of arrow 122 while pulling friction plug assembly 108 into hole 28.

When properly seated (as shown in FIG. 4B), the direction of rotation of high-tensile-strength shank assembly 100 may then be reversed (i.e., rotated in the direction of arrow 132), resulting in friction plug assembly 108 unscrewing from high-tensile-strength shank assembly 100 and external male thread assembly 112 protruding out of hole 28 (which is now plugged). External male thread assembly 112 may then be ground smooth with surface 134 of pieces 10, 12 (as shown in FIG. 4C), thus completing the plugging procedure.

### General:

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A high-tensile-strength shank assembly comprising:
a shaft assembly;
a first distal end configured to releasably engage a friction plug assembly; and
a second distal end configured to releasably engage a friction pull welder assembly.

2. The high-tensile-strength shank assembly of claim 1 wherein the first distal end includes a thread assembly configured to releasably engage the friction plug assembly.

3. The high-tensile-strength shank assembly of claim 1 wherein the second distal end includes a thread assembly configured to releasably engage the friction pull welder assembly.

4. The high-tensile-strength shank assembly of claim 1 wherein the friction plug assembly is a flared friction plug assembly.

5. The high-tensile-strength shank assembly of claim 4 wherein the first distal end includes a flared portion having a flare profile similar to the flared friction plug assembly.

6. The high-tensile-strength shank assembly of claim 1 wherein the high-tensile-strength shank assembly is constructed of a material having a tensile strength of at least 20,000 pounds per square inch.

7. The high-tensile-strength shank assembly of claim 1 wherein the high-tensile-strength shank assembly is constructed of a ferrous material.

8. The high-tensile-strength shank assembly of claim 1 wherein the high-tensile-strength shank assembly is constructed of inconel.

9. The high-tensile-strength shank assembly of claim 1 wherein the friction plug assembly is constructed of a nonferrous material.

10. The high-tensile-strength shank assembly of claim 1 wherein the friction plug assembly is constructed of aluminum.

11. A high-tensile-strength shank assembly comprising:
a shaft assembly;
a first distal end configured to releasably engage a friction plug assembly, wherein:
the first distal end includes a thread assembly configured to releasably engage the friction plug assembly, and
the friction plug assembly is constructed of aluminum; and
a second distal end configured to releasably engage a friction pull welder assembly.

12. The high-tensile-strength shank assembly of claim 11 wherein the second distal end includes a thread assembly configured to releasably engage the friction pull welder assembly.

13. The high-tensile-strength shank assembly of claim 11 wherein the friction plug assembly is a flared friction plug assembly.

14. The high-tensile-strength shank assembly of claim 13 wherein the first distal end includes a flared portion having a flare profile similar to the flared friction plug assembly.

15. The high-tensile-strength shank assembly of claim 11 wherein the high-tensile-strength shank assembly is constructed of a material having a tensile strength of at least 20,000 pounds per square inch.

16. The high-tensile-strength shank assembly of claim 11 wherein the high-tensile-strength shank assembly is constructed of a ferrous material.

17. The high-tensile-strength shank assembly of claim 11 wherein the high-tensile-strength shank assembly is constructed of inconel.

18. The high-tensile-strength shank assembly of claim 11 wherein the friction plug assembly is constructed of a nonferrous material.

19. A high-tensile-strength shank assembly comprising:
a shaft assembly;
a first distal end configured to releasably engage a friction plug assembly, wherein:
the first distal end includes a thread assembly configured to releasably engage the friction plug assembly, and
the friction plug assembly is constructed of aluminum; and
a second distal end configured to releasably engage a friction pull welder assembly, wherein the second distal end includes a thread assembly configured to releasably engage the friction pull welder assembly;
wherein the high-tensile-strength shank assembly is constructed of a ferrous material.

20. The high-tensile-strength shank assembly of claim 19 wherein the high-tensile-strength shank assembly is constructed of a material having a tensile strength of at least 20,000 pounds per square inch.
